(19) United States
(12) Patent Application Publication
(10) Pub. No.: US 2007/0288473 A1
(43) Pub. Date: Dec. 13, 2007

(54) Refining search engine data based on client requests

(76) Inventors: Rajat Mukherjee, San Jose, CA (US); Kalpana Ravinarayanan, Sunnyvale, CA (US)

Correspondence Address: Hickman Palmero Truong & Becker LLP/;Yahoo! Inc., 2055 Gateway Place, Suite 550, San Jose, CA, 95110-1089, US

(21) Appl. No.: 11/450,590

(22) Filed: Jun. 8, 2006

(51) Int. Cl. G06F 17/30

(52) U.S. Cl. 707/10

(57) ABSTRACT

When a client application, such as a web browser, is used to navigate documents, search engine data, additional navigation data, and other metadata can be displayed to the user within the client application. Navigation data is logged and recorded as users transition from one document to another in in the client application. The recorded navigation data is analyzed and refined in order to identify navigation trends among users. The navigation trends are used to define associations between documents. The resulting document associations can be displayed to the user as the user navigates documents. Moreover, the displayed associations can be dynamically updated as a user transitions from one document to another.

### BACKGROUND

A variety of mechanisms are available to help users search and navigate electronic information. For example, many electronic resources employ a search engine to help users locate information. To locate information on a particular topic, a search engine allows users to submit one or more search query terms related to a topic of interest. In response, the search engine executes the search query, consults its indexes, and generates information about the results of the search. The information about the results of the search, referred to herein as the “search results”, usually contains a list of resources that satisfy the search query and some attributes of those sources.

While search engines may be applied in a variety of contexts, one common use is navigating through document repositories by searching for documents of interest. Therefore, web search engines are especially useful for locating resources that are accessible on the Internet, as the Internet can be thought of as a large repository of resources. Many searching techniques may be used by Internet search engines. For example, an Internet search engine might read or “crawl” pages on the Internet to create entries for a search index, and then use that index when determining which pages are relevant to a search query. Accordingly, current web search engines have very large document indexes, which means that the web search engines can provide deep coverage of Intenet resources.

The resources identified in Internet search results often include files whose content is composed in a page description language such as Hypertext Markup Language (HTML). Such files are typically called web pages. Using a web browser, a web page may be retrieved by entering its Universal Resource Locator (URL) in a web browser. A URL is basically the electronic address of a web page. Internet search results may therefore be presented to a user as a list of hypertext links to the URLs of matching resources. Users retrieve a document or resource of interest found in a search by selecting, in a web browser, the resource's hypertext link or URL found in the search results.

Unfortunately, search results may contain so many matching resources that a user may be overwhelmed by the results. Therefore, a number of techniques have been designed to assist the user in their search. For example, search results frequently include a short description or “abstract” with each matching resource. Abstracts are relatively short, so that a user may quickly judge the relevance of a matching resource listed in the search results. These abstracts may be contextual or static. A contextual abstract is one that is generated dynamically based on the search query terms submitted by a user. A static abstract is a short summary of the contents of a web page. This can be algorithmically determined by a computer program, or input by a user (e.g., typically, by the web page's publisher). By viewing an abstract, a user can quickly determine if a matching resource is relevant to their search.

As useful as abstracts and other search tool features may be in helping a user find useful information, conventional searching techniques have limitations. For example, web search engines rely almost exclusively on search terms provided by a user to find and display information to a user. As a result, the search results suggested by a search engine are heavily based on the search terms and do not take into account other forms of data that may be useful in helping a user find useful and interesting information on the web.

The approaches described in the section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of an example environment for collecting, generating, and displaying destination data.

FIG. 2 illustrates an example user interface for a toolbar that implements an embodiment of the invention.

FIG. 3 illustrates an example user interface for a web browser that implements an embodiment of the invention.

FIG. 4 is a block diagram of a computer system on which implementations of the present invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques described herein provide mechanisms for dynamically generating search results-like information based, in part, on trends identified in users' browsing history. For example, in one embodiment, a user logs onto a computer and launches a browser to access a document corpus, such as the Internet. According to one embodiment, the browser includes a tracking mechanism, such as a browser toolbar or plugin, to log and track the user's browsing activity. For example, as the user browses from one document to another in the document corpus, each transition is recorded by the tracking mechanism. These document transitions along with other information are collected as “raw navigation data.” Raw navigation data refers generally to all the information recorded as a user browses a document corpus. For example, raw navigation data includes the document address of an accessed document in the document corpus, any available metadata about the accessed document (e.g., author, publisher, title, date, etc.), information about the user browsing the document (e.g., user demographic information, user credentials, name, etc.), statistical information about the browsing habits of the user (e.g., time spent on a page, how often the user returns, etc.), and other data associated with document browsing. In one embodiment, the raw navigation data includes hardware addresses, IP addresses, IPX addresses, etc.

In another embodiment, the only information sent by the tracking mechanism is the address (URL) of the document. All further processing and refinement is performed by a refining mechanism.

According to one embodiment, the raw navigation data is recorded by the tracking mechanism and then forwarded to a refining mechanism, such as a search engine, to be analyzed. The reason for analyzing the raw navigation data is to identify browsing trends and patterns that can provide users with useful suggestions and links to other documents and/or information when a user accesses a particular document in the document corpus. For example, suppose a user browses to a sports news document in the document corpus and then subsequently browses to a document that discusses a specific sports team. Ordinarily, such a transition may not seem important. However, if a large number of other users make the same transition, e.g., browse to the sports news document and then transition to the team document, then the refining mechanism stores this trend since users of the sport news document also appear to be interested in that particular team document. The process of filtering and identifying trends in the raw navigation data by the refining mechanism produces “refined navigation data”.

Refined navigation data generally refers to raw navigation data that has been filtered by the refining mechanism to remove improper, excess, and redundant data. For example, refined navigation data may include data that has been screened for obscene or illicit information. Similarly, refined navigation data may exclude links to invalid documents or resources in the document corpus. Refined navigation data includes browsing trends and patterns identified by the refining mechanism from users' browsing histories.

In one embodiment, refined navigation data may also refer to other information retrieved from the browser. That other information can include metadata extracted from a document, text extracted from the document, or information about the user (e.g., demographic information). Basically, the refining mechanism generates the refined navigation data from the raw navigation data. In one embodiment, the refining mechanism is able to forward a portion of the refined navigation data back to the user browser to be displayed to the user through a display mechanism.

In one embodiment, the browser includes a display mechanism, such as user interface controls, to display refined navigation data to the user when the user accesses a particular document. For example, suppose a user browses the above-mentioned sport news document. In one embodiment, upon accessing the sport news document, the user browser sends a request message to the refining mechanism, requesting, in part, refined navigation data associated with the sport news document. According to one embodiment, the refining mechanism returns a link to the team document, among other information, to the browser. The refined navigation data is displayed by the display mechanism to the user. The refined navigation data provides suggestions to the user of other documents or information that may be interesting and/or useful to them. In one embodiment, the refined navigation data is updated by the browsing mechanism as the user browses from one document to the next.

According to one embodiment, the display mechanism may also receive and display other information other than just refined navigation data. For example, information such as search engine results, results from an unrelated document corpus, and other related topics. In the sports news example described above, game results and scores may be displayed along with a link to a team page.

According to one embodiment, feed-based data is also received from the refining mechanism and displayed to the user.

According to one embodiment, the refined navigation data, or other data can be provided by the search engine itself, although other systems may be used in the background, e.g., news or finance services.

### Web-Based Environment

Even though the techniques described herein are described in terms of a search engine and/or Internet environment, these environments are meant only to serve as exemplary environments in which the techniques of the present invention are employed. In alternative implementations, the techniques may be employed in other environments. For example, the techniques could be employed outside a web browser in a news reader application, or desktop search application, or document editor.

### Destination Data

The techniques and tools described herein provide mechanisms for displaying, in a user interface, destination data to a user as the user browses a web page. For example, as a user browses a web page in a web browser, user interface controls built into the web browser (or generated by a tool associated with the web browser) display destination data to the user. “Destination data” can include a wide range of information. Examples of destination data include, but are not limited to, (1) refined navigation data, (2) search engine data, and (3) feed-based data. Each of these types of destination data will be described in greater detail hereafter.

### Refined Navigation Data

As noted above, refined navigation data generally refers to raw navigation data that has been collected by a tracking mechanism as a user browses the Internet and then analyzed by a refining mechanism. The raw navigation data includes URLs, web page transition information (e.g., what web page a user was accessing and what web page (s) the user subsequently accesses), user demographic information (e.g., most users are teenagers), statistical or metric information (e.g., how long a user spent browsing a web page, how often the user accesses the web page, etc.). In one embodiment, raw navigation data is forwarded by the tracking mechanism to a refining mechanism, such as a search engine.

At the refining mechanism, the raw navigation data is analyzed in conjunction with raw navigation data collected from other users to identify patterns and trends in the users' browsing histories. For instance, suppose a significant number of web users access a banking web page (through their web browser) and then a few clicks later access the same financial planning web page. In one embodiment, the transition from the banking web page to the financial planning web page is collected by a user's web browser (or by a collection tool associated with the web browser) and forwarded to a search engine to be analyzed and refined. At the search engine, if the transition from the banking web page to the financial planning web page appears frequently among users of the banking web page, the search engine creates an association between the banking web page and the financial planning web page and stores that association. In one embodiment, the association between the banking web page and the financial planning web page is included in the refined navigation data.

Refined navigation data also includes, but is not limited to, raw navigation data that has been filtered for improper, erroneous, excess, and redundant information.

In one embodiment, when a user accesses a web page, the web browser for the user receives and displays, among other data, refined navigation data from the refining mechanism. For example, in the scenario described above, when a user accesses the banking web page, the user's web browser displays a link to the financial planning web page since the refining mechanism has determined that users of the banking web page are also interested in the financial planning web page. In this way, refined navigation data provides users of a web page with information that was useful or of interest to other users of the same web page.

In one embodiment, to improve a user's browsing experience, refined navigation data may be dynamically updated in the user's web browser as the user transitions from one web page to the next. In addition, in one embodiment, the refined navigation data associated with a given resource can change over time, e.g., to reflect new products, associations or trends.

### Search Engine Data

In addition to refined navigation data, destination data includes search engine data. Search engine data generally refers to any information generated and indexed by a search engine. Search engine data can include static abstracts, active abstracts, additional links related to a particular web page, search results based on search queries, related topics and keywords, other suggested queries, and other such information. Search engine data also includes other data and metadata about a page, e.g., publisher, date, author, tags, text from a web page, data from other repositories, etc.

### Feed-Based Data

Destination data can also include feed-based data. Generally, feed-based data refers to information submitted to a search engine by a web page publisher and/or advertiser. The process of submitting feed-based data to the search engine varies. However, the typical example of feed-based data involves a web page publisher or advertiser establishing an online account with a search engine and submitting data to the search engine. For example, through an online account, a web page publisher accesses links to their own web page and submits specific information that they would like to be displayed whenever a user accesses or performs a search on their web page. Feed-based data can include links to other web pages, promotional offers, metadata (e.g., information about the title, author, date and publisher of a web page), keywords, and other related topics that may be useful to a user browsing a web page. In one embodiment, feed-based data may also be displayed in a search engine results page.

For example, suppose a bank would like to highlight the low mortgage interest rates the bank is offering to visitors of its main web page. To do so, the bank creates a separate web page advertising their low mortgage interest rates. However, an analysis of users' activity on the bank's main web page indicates that visitors for one reason or another are not accessing the interest rate web page. To give the interest rate web page additional exposure, the bank's web page publisher accesses an online account with a search engine and requests that the search engine associate the interest rate web page with the bank's main web page in search results associated with the bank. Then, when subsequent visitors access the bank's main web page, in one embodiment, the search engine sends the address to the bank's interest rate web page as part of the destination data. Accordingly, the interest rate web page address is displayed as destination data when visitors access the bank's main web page. According to one embodiment, it is possible for the actual interest rates to be sent as part of the destination data, e.g., as supplied by the bank to the search engine as a feed.

Similarly, advertisers may submit information to a search engine and request that the submitted information be associated with a particular web page. In one embodiment, however, an advertiser can only submit advertiser-specific data to the search engine once a web page publisher and the advertiser have agreed to contractual terms and the web page publisher has notified the search engine of the contractual terms. In another embodiment, an advertiser can only submit advertiser-specific data to the search engine once the search engine and the advertiser have agreed to contractual terms. In another embodiment, the advertiser is also the publisher of the page.

In one embodiment, the feed-based data may be submitted in any authorized format, such as email, letter, fax, other form of communication.

### Exemplary System

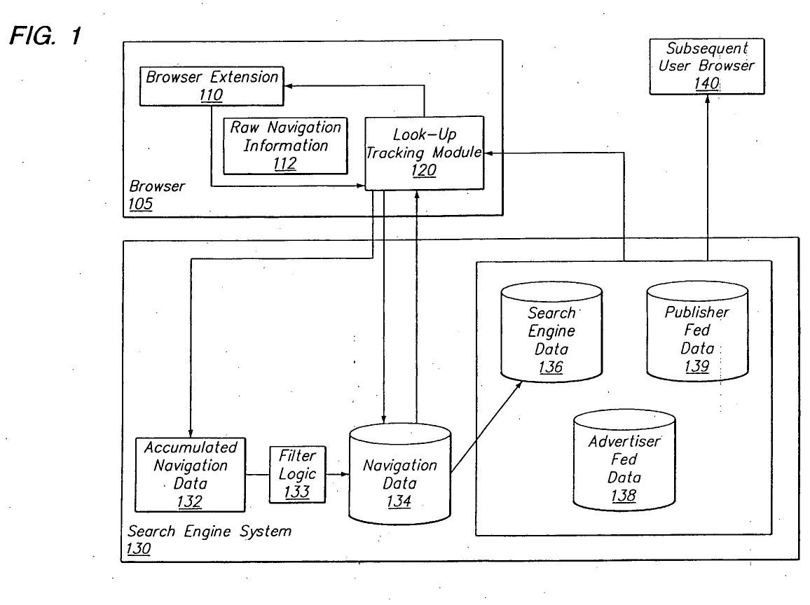

FIG. 1 illustrates an exemplary system 100 for collecting, generating, and displaying destination data to a user. To collect, generate, and display the destination data, three separate tools of system 100 are illustrated in FIG. 1. In one embodiment, those tools include browser 105, search engine 130, and subsequent user browser 140. In other embodiments, system 100 may include a different set of tools and components.

### The Browser

Browser 105 generally represents any software tool that allows a user to browse, navigate or view electronic documents. For example, browser 105 may be a web browser, a document viewer, RSS newsreader, mail client, document editor, a database client application, or other software tool for navigating a document corpus. As illustrated, browser 105 includes several components, such as browser extension 110 and look-up and tracking module 120.

In one embodiment, browser extension 110 is a stand-alone application such as a desktop application, screen saver, or some other application with user interface controls to display destination data, among its other functions. Alternatively, browser extension 110 is a tool designed to work in connection with browser 105. For example, browser extension 110 can be a module of, extension to, or plug-in for browser 105. In one embodiment, browser extension 110 is a toolbar application installed and integrated into browser 105.

In one embodiment, browser extension 110 provides a variety of features to the user. For example, browser extension provides a sign-in feature, user interface controls to display destination data, a search function, links to other web pages, user interface controls that let the user specify what type of information is collected, and other such features. In one embodiment, browser extension 110 activates look-up and tracking module 120 upon user sign-in.

In one embodiment, sign-in may be implicit upon launch of the browser.

In one embodiment, look-up and tracking module 120 is an application programming interface file, a dynamic link library file, a separate application, an integrated component of browser 105, or some other software tool that defines an interface between browser 105 and data repositories and/or a search engine, such as search engine 130. In addition, look-up and tracking module 120 can act as a tracking mechanism to collect web page addresses and other raw navigation data from browser 105 and forward the information to search engine 130. In an alternative embodiment, a tracking module separate from the look-up and tracking module may be used to collect the raw navigation data.

In one embodiment, look-up and tracking module 120 forwards raw navigation data to the search engine at the time the raw navigation data is collected (e.g., look-up and tracking module forwards the raw navigation data for a single web page upon access). Alternatively, look-up and tracking module 120 collects raw navigation data from one or more web pages and sends it to the search engine at predetermined intervals or when a certain amount of raw navigation data has been collected.

In one embodiment, look-up and tracking module 120 captures a single web page address and forwards the web page address to the search engine independently of other information. The search engine performs a look-up to see if there is any destination data associated with the web page address and returns any associated destination data. The destination data is returned to look-up and tracking module 120. From look-up and tracking module 120, the destination data is sent to browser 105 where it is displayed as suggestions, additional information, or related information. Destination data is displayed, in one embodiment, using user interface controls that are a part of browser extension 110.

It should be noted, that in one embodiment, the destination data may be sent directly to browser 105 or browser extension 110, bypassing look-up and tracking module 120.

In one embodiment, look-up and tracking module 120 can filter the raw navigation data before submitting the raw navigation data to search engine 130. For example, the look-up and tracking module may remove personal information (e.g., name, age, address, social security number, etc.), credit card information, or other sensitive information before sending the raw navigation data. In one embodiment, browser extension 110 provides user interface controls that allow the user to selectively choose what information is filtered by look-up and tracking module 120.

In one embodiment, login may not be required and only anonymous or demographic data is sent to the search engine 130.

### Example Operation

Suppose a user opens a browser 105, such as a web browser, with an integrated browser extension 110, such as an integrated search engine toolbar. In this example, raw navigation data 112 is collected by look-up and tracking module 120 that interfaces with the browser extension 110 and search engine. According to one embodiment, before any raw navigation data 112 is collected, the user is prompted to register with search engine 130. The process of registering is generally well-known and is not discussed in detail herein. It should be noted, however, that registering can include an initial registration process and additional sign-in processes once the initial registration is complete. Asking a user to register (or sign-in) with the search engine provides a mechanism that allows users to opt-in to the browser tracking service. Alternatively, raw navigation data is collected anonymously as the user browses the web, or with one-time user consent, e.g., at registration.

Once a user has registered, in one embodiment, browser extension 110 activates look-up and tracking module 120. By activating look-up and tracking module 120, it begins to collect raw navigation data as the user transitions from one web page to the next. The amount of raw navigation data captured by look-up and tracking module 120 varies. Factors that influence the amount of raw navigation data collected include the type of web page being browsed, how much information is associated with a web page, what type of information is allowed to be collected (e.g., the user may have filtered the type of information that can be collected using controls in the browser extension), how often the raw navigation data is to be sent to the search engine, what type of information the search engine requires to refine the navigation data, and other such factors.

As an example, suppose a user browses to a web page that does not have much very information either on the web page itself or in the web page's associated metadata. In this example, the amount of raw navigation data collected by a look-up and tracking module about this particular web page may be small. For example, the look-up and tracking module may only collect the web page address the user was at just prior to the current web page and the current web page address.

Alternatively, the user may browse to a web page rich with content. In this example, more raw navigation data may be collected by look-up and tracking module. For example, the collected raw navigation data may include the URL for the current web page, the web page's title and publisher information, publication date, email addresses embedded in the web page, keywords automatically generated by an analysis of the web page's content by the browser extension, statistical information such as the time spent on the web page, graphic images, links to other web pages extracted from the web page's content by the browser extension, and other such information. The raw navigation data also includes a user's browsing history (e.g., what URLs the user accessed while they have been browsing the web).

Now, suppose a user accesses a bank's web page to check an online banking account. Then, suppose, the user navigates to a web page that discusses investment funds. The transition from the banking web page to the investment fund web page is included in the raw navigation data collected by look-up and tracking module 120 and forwarded to search engine 130. If the user later transitions from the investment fund web page to an electronic gadgets web page, that transition is also recorded by the look-up and tracking module 120. Subsequent transitions are also recorded.

Once raw navigation data has been collected, it is sent by look-up and tracking module 120 to search engine 130. The raw navigation data can be sent as a single web address, a text file, a list of data, a table, as a series of messages, a single message, or other format depending on the defined interface between browser 105 and search engine 130. Upon receipt of the raw navigation data, search engine 130 stores it until the raw navigation data can be analyzed.

In one embodiment, the raw navigation data is accumulated at the search engine.

According to one embodiment, the raw navigation data includes a request message. The request message is generated by look-up and tracking module 120 when a user accesses a new web page. The request message contains the web page address of the web page the user is browsing and indicates a request that the search engine provide destination data for that particular web page address. For example, suppose a user opens a browser and accesses a web page on the Internet. Upon access of the web page, the look-up and tracking module for the browser intercepts the web page address (or other information from which the electronic address may be derived), creates a request message, and sends the request message to the search engine. The search engine receives the request message and performs a search to determine if there is any destination data associated with the requested web page. If destination data associated with the web page address is found, then the destination data is sent back to the browser. The Search Engine can also record the navigation data at this time, e.g., the requested URL of the web page.

### Example Search Engine

Search engine 130 includes software tools to analyze raw navigation data and to send destination data to browser 105 for display to the user. In one embodiment, search engine 130 includes accumulated navigation data 132, filter logic 133, a refined navigation data repository 134, a search engine data repository 136, a publisher data repository 139, and an advertiser data repository 138. In other embodiments, the search engine 130 may include a different set of components.

Accumulated navigation data 132 generally refers to a repository, such as a database, for storing raw navigation data received by search engine 130 from look-up and tracking modules. The accumulated navigation data collects raw navigation data from multiple users into a single repository.

The refined navigation data repository 134 generally refers to a repository, such as a database, for storing refined navigation data after it has been filtered by filter logic 133.

### Filter Logic

Filter logic 133 is hardware and/or software logic that analyzes the accumulated navigation data in order to, among other things, find trends and common patterns in user browse histories. The filter logic 133 evaluates the accumulated navigation data to generate refined navigation data about a web page that can be displayed to subsequent users when those users access that particular web page. For example, suppose a user opens his web browser to a sports-related web page and then navigates to a specific sports team web page. As discussed above, in one embodiment, that transition is recorded and sent to the search engine. In some instances, the transition from the sports-related web page to the team web page may not seem important. However, if a relatively large number of users that browse the sports-related web page eventually browse to the same team web page (whether it is one click, two clicks, or several clicks later), then that transition becomes more interesting. That transition can indicate that users who access the sports-related web page may also be interested in that particular team's web page. Therefore, in one embodiment, the transition from the sports-related web page to the team web page is extracted by the filter logic 133 and placed in the refined navigation data repository 134. Then when the search engine receives a request message for destination data for that particular sports-related web page, the search engine includes the team web page as part of the destination data since users of the sports-related web page seem to have also found the team web page interesting.

Note that web page transitions do not need to be immediate to each other to be important to the analysis performed by filter logic 133. For example, the user accessing the sports-related web page may access a banking web page, then a web page giving financial tips, a current events web page, before finally accessing the team web page. In such a case, since the user eventually accessed the team web page during the same browsing session as the sports-related web page (e.g., the same “clickstream”), the filter logic 133 can use that information when it identifies common trends and patterns in user browse histories. It should be noted that the distance between two web pages in the clickstream can be a factor in determining whether two web pages constitute a pattern or trend in user browse histories and whether the two web pages should be associated together in the refined navigation data. For example, if a user accesses the sports-related web page and five hundred clicks later accesses the team web page, then the association between the two web pages may be weak. Basically, the filter logic 133 evaluates a variety of factors to determine the relevance and the strength of association between two web pages. Some of those factors to evaluate the relevance and strength of association between two web pages include the number and/or percentage of users who access common web pages, the subject categories of the pages, the user demographics, the time and number of clicks between accesses to the two web pages, the computing resources available to analyze and filter the accumulated navigation data, overall popularity of a web page, user-based rankings, and other such factors.

As described above, the raw navigation data from which accumulated navigation data 132 is based can include a wide-range of additional information, including the amount of time a user spends browsing a web page and overall user demographics. The filter logic 133 can use those additional details to further refine the accumulated navigation data.

To illustrate, suppose in its analysis of the sports-related web page, the filter logic 133 determines that users who access the team web page only spend a few seconds on the team web page before transitioning back to the sports-related web page or browsing to another web page. In such a case, the filter logic 133 may determine that the team web page really is not of interest to users of the sports-related web page since users did not spend much time browsing the web page. Accordingly, filter logic 133 excludes that particular transition from the refined navigation data. Other factors may similarly exclude and filter data from being stored in the refined navigation data repository.

In one embodiment, filter logic 133 analyzes raw navigation data from a specific user, client machine, or browser. In such an embodiment, filter logic 133 may even be integrated into browser 105. For example, suppose a user browses a particular set of web pages every day. The web pages include a sports news web page, an investment fund web page, a current events web page, etc. In one embodiment, a look-up and tracking module collects raw navigation data about the web pages the user accesses and, instead of sending the raw navigation data to the search engine, the look-up and tracking module forwards the raw navigation data to filter logic incorporated into the browser extension. The filter logic in the browser extension evaluates the user's own browse history for trends and patterns. Basically, the web pages accessed by the user are analyzed and filtered in a way similar to the manner described above in connection with the accumulated navigation data. Accordingly, when the user accesses a given web page, destination data based on the user's own browsing history is displayed by the browser extension.

For example, assume the first web page a user accesses when they launch their web browser in the morning is a sport news web page. After reading the sport news, the user accesses an investment fund web page and then a team web page. This is the user's routine when browsing web pages. The page transitions and other raw navigation data is collected by a look-up and tracking module and forwarded to filter logic in the browser extension. The filter logic analyzes the raw navigation data collected from the user's browsing activity and generates destination data to be displayed when the user accesses a particular web page. For example, analysis of the raw navigation data for this user would generate an association between the sports news web page and the investment fund web page. Thus, on a subsequent access of the sports news web page, the browser extension displays in a user interface control a link to the team web page. In one embodiment, the link could include additional information such as an abstract of the team's last game, thumbnail photos of player's on the team, scores, related topics, and other information.

In one embodiment, the filter logic 133 also excludes invalid document addresses, as well as, document addresses that reference offensive material.

### Other Data Repositories

Search engine data repository 136 refers to a repository, such as a database, that includes search engine data. For example, in a web environment, Yahoo!, Google, MSN Search, and other Internet search engines, all have vast stores of data that have been indexed according to various proprietary algorithms and techniques. In one embodiment, search engine data repository 136 includes information from those vast stores of data. Search engines analyze the data in the search engine repositories to provide search results to users.

The publisher data repository 139, in one embodiment, contains information submitted to the search engine by the owners and/or publishers of a document. The type of information a publisher can feed to the search engine varies. In one embodiment, the publisher-fed data includes information such as stock quotes, graphics, links to partner web pages, links to reviews of a product, promotional offers, and other such information.

To actually submit publisher data to the search engine, the publisher typically has to have an account with the search engine. A publisher's account with the search engine generally allows the publisher to associate submitted information with particular web page addresses. For example, a web page publisher can create an account (through a registration process) with a search engine, such as Yahoo!. Typically, the account lists web pages for which the publisher can submit its own information. Accordingly, when the publisher wants to associate specific links or other information with a particular web page, the publisher logs into their search engine account, and directly submits the information to the search engine. This can happen via feeds of data, using RSS, XML, text or other formats. The submitted data is stored in publisher data repository 139.

Similarly to publisher submitted data, information stored in the advertiser data repository 138 can include a variety of information, such as advertisements, promotional offers, giveaway items, links to online stores, etc. However, instead of being fed to the search engine by the publisher of a document, the information stored in advertiser data repository 138 is submitted by advertisers. In one embodiment, an advertiser can only submit advertiser data to the search engine once the publisher and advertiser have agreed to contractual terms and the publisher has indicated to the search engine that the advertiser has the right to advertise in connection with their web page.

In another embodiment, the data stored in the advertiser data repository 138 also includes advertising information negotiated between an advertiser and the search engine. In such a case, when advertiser data is included as destination data, the advertiser data is displayed in a user interface control separately from the underlying publisher document to keep the advertiser data separate from publisher data.

In one embodiment, the search engine enforces rules to prevent an advertiser from including advertising data in connection with a competitor's web page.

Note that information in the publisher data repository 139 and advertiser data repository are retrieved by the search engine at the same time other data, such as the refined navigation data or search engine data, is retrieved.

Although, various repositories have been described, it should be noted that, in one embodiment, the information contained in the described repositories can be separated into more repositories or combined into fewer repositories. In one embodiment, all the information associated with destination data is combined into a single search engine repository.

In another embodiment, the search engine can use proprietary algorithms to dynamically determine what data to provide as destination data. These algorithms could involve classifying a URL being looked up. For instance, the search engine may only provide advertiser data in the destination data when a URL is a commercial URL (e.g., a URL with a “.com” extension).

Once the various forms of data have been analyzed, sorted, stored and indexed by the search engine, the data is available to be included as destination data upon request by a browser (or component thereof).

For example, in one embodiment, a subsequent browser 140 accesses a document. In one embodiment, the subsequent browser has all of the components described in connection with browser 105 (including a browser extension and look-up and tracking module). Accordingly, the subsequent browser 140 can send a request message with a web page address to the search engine for destination data associated with that particular web page. In return, the search engine sends destination data that is displayed in the browser when the destination data is received.

In one embodiment, subsequent browser 140 does not include the browser extension or look-up and tracking module. Yet, a user of this subsequent browser may still receive the benefits of destination data. When the user accesses a search engine and performs a search in the search engine, the user may receive enhanced search results that include information not only from the search engine repository, but results from the refined navigation data repository, publisher data repository, and advertiser data repository.

### Display Destination Data

When destination data is received by a browser from the search engine, the destination data is displayed to the user in a display interface. In one embodiment, the display interface is a user interface control by browser 105. Alternatively, the display interface is a user interface created by the browser extension 110.

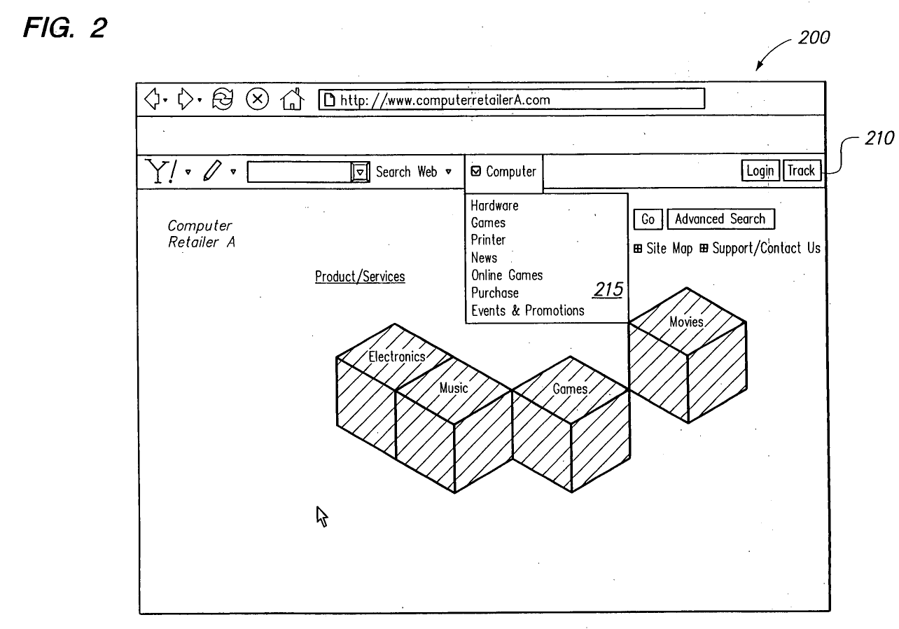

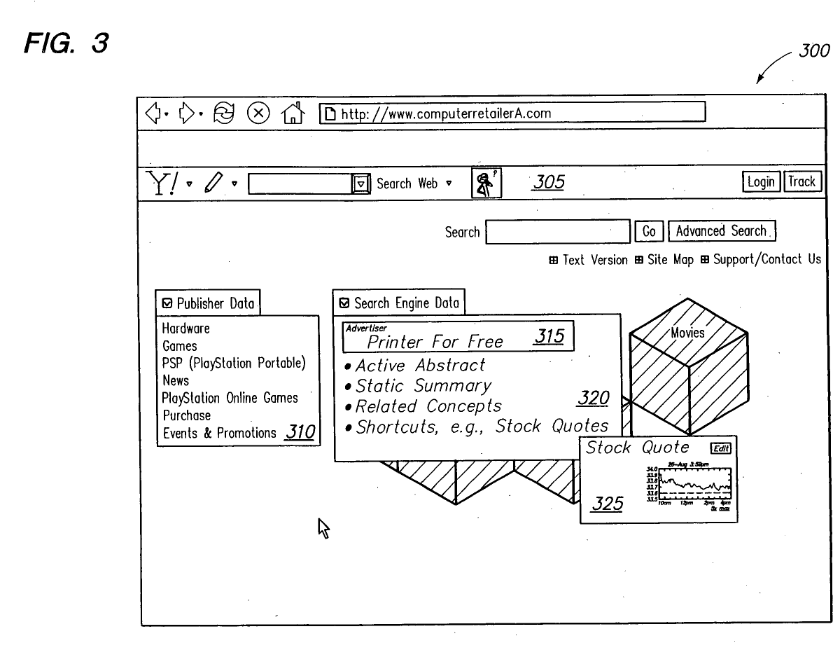

FIG. 2 illustrates a sample web browser user interface 200 with an integrated toolbar 210 having a display interface 215. The display interface 215 in this case is a pull-down menu that shows destination data to a user. FIG. 3 illustrates a different web browser user interface 300 that includes a button on the toolbar that automatically sends a request message to the search engine to retrieve destination data when the button is clicked. In this user interface, the display interface includes overlay windows 310, 315, and 320. Overlay windows 310, 315, and 320 display destination data. In other embodiments, the display interface may be another type of user interface control, such as scroll bars, pop-up windows, frames, etc.

The actual ordering and amount of destination data displayed in the display interface varies based on implementation. In one embodiment, the user can selectively choose how much destination data is shown in the display interface. For example, browser extension 110 includes controls that allow the user to choose how many lines of destination data are to be displayed in the display interface. Moreover, browser extension can provide controls that allow the user to select what type of destination data is displayed in the display interface. For example, the user may only want to see refined navigation data in the display interface. Accordingly, the user is provided with controls that allow them to select only refined navigation data. In one embodiment, the user can select how much of each type of data will be displayed. For example, the user may want abstracts and related topics to be displayed in connection with search engine data. Accordingly, the user selects the appropriate controls to show abstracts and related topics in the destination data. Alternatively, the user may just want to see links to other web pages. Therefore, the user selects controls to limit the displayed destination data to links. Basically, the display interface is customizable and allows the user determine how much destination data will be displayed.

### Procedure for Gathering and Displaying Destination Data

To illustrate the procedure for collecting, refining, and displaying destination data, consider the example of George. George is a typical computer-user who wants to buy a new computer over the Internet. To buy his computer, George accesses the Internet through an application, like browser 105 with browser extension 110. In George's case, the application is a web browser with an integrated toolbar. The toolbar includes a tracking mechanism, such as look-up and tracking module 120, to track George's Internet usage and send the tracked data (e.g., raw navigation data) to a search engine 130. In one embodiment, the toolbar also includes a display interface for displaying destination data to George. As described above, FIGS. 2 and 3 illustrate example display interfaces for displaying destination data.

As George begins to browse the web, George is concerned about protecting what personal information is allowed to be sent over the Internet. Accordingly, the toolbar installed by George does not track any information unless George opts to have his Internet usage tracked. In one embodiment, George agrees to have his web browsing activity recorded when he registers for an online account with a search engine. Accordingly, once George has registered and logged into his online search engine account the toolbar's tracking mechanism begins to collect raw navigation data about the web pages he visits. While George is not registered (or not logged in) his browsing activity is not tracked. Moreover, in one embodiment, the toolbar includes a button that allows George to selectively control when raw navigation data is collected. For example, once logged into his search engine account, George may yet decide he does not want his Internet activity tracked while he provides credit card and other sensitive financial information to an online computer retailer. Therefore, before purchasing a computer, George may click on a “stop tracking” button on the toolbar to stop the collection of raw navigation data until he decides to allow the tracking mechanism to start recording his browsing activity again.

In one embodiment, certain statistics gathered at the time of registration such as a user's age, sex, race, etc. may be collected to identify the demographics of users accessing a web page. That information may be used to refine raw navigation data that may be of interest to particular demographic groups.

In one embodiment, the toolbar does not record any personal information (e.g., name, passwords, credit card information, etc.). In this embodiment, the toolbar's tracking mechanism merely records information about George's Internet usage, e.g., the web pages he visits, the time he spends on a page, etc. The filtering of personal information may be done by the tracking mechanism. For example, the toolbar in George's web browser provides user interface controls that allow George to specify specific types of information that should be filtered and excluded from being collected in the raw navigation data. Thus, George may elect to have his name, credit card information, and other private information be excluded from ever being collected. In one embodiment, the raw navigation data is submitted anonymously by the tracking mechanism to the search engine.

The process of capturing the raw navigation data involves capturing URLs and other information associated with web pages accessed by George. For example, when George accesses a banking web page, the address and other raw navigation data is captured and recorded by the tracking mechanism. From the banking web page, George navigates to a new page. The transition from the banking web page to the new web page is recorded. As George navigates from web page to web page, each transition is recorded so it can eventually be evaluated to find trends and create associations between web pages.

Periodically, the raw navigation data collected from George's browsing activity is forwarded by the tracking mechanism to the search engine. In one embodiment, the tracking mechanism facilitates the transmission of the raw navigation data to the search engine by establishing an interface between George's web browser and the search engine.

Once the interface has been created, the raw navigation data collected by the tracking mechanism is sent to the search engine, where it is stored with the user browse histories of other users. In one embodiment, the raw navigation data is accumulated into a repository such as accumulated navigation data 132 described in connection with FIG. 1. Then, the accumulated navigation data is refined. In one embodiment, filter logic, such as the filter logic 133 described in connection with FIG. 1, is used to analyze the accumulated navigation data in order to find trends and patterns in the users' browse histories. The resulting patterns and filtered information is stored as refined navigation data in a repository, such as refined navigation data repository 134 described in connection with FIG. 1.

For example, if a large number of users access computer retailer A's web page and then later access computer retailer B's web page, the search engine evaluates that information and determines that users who were interested in computer retailer A's web page were also interested in computer retailer B's web page. Alternatively, if a large number of users access computer retailer A's web page and then click on a “Customize Computer” option on computer retailer A's web page, the “Customize Computer” option may be identified as a web page that may be useful or of interest to visitors of computer retailer A's web page.

Note that destination data is not limited to information that directly relates to a particular web page. For example, a large number of users may access computer retailer A's web page and later (e.g., 3 or 4 or 10 clicks later) navigate to a sports-related web page. Even though the sports-related web page may not be traditionally associated with a computer retailer's web page, the fact that many users access computer retailer A's web page and then go to the sports-related web page indicates that the sports-related web page may be of interest to subsequent visitors to computer retailer A's web page. Accordingly, upon analysis of the accumulated navigation data, the sports-related web page is extracted and associated with computer retailer A's web page. The association is stored in the refined navigation data repository.

By evaluating the accumulated navigation data, it is possible to identify trends and user browsing patterns and then display those trends and browsing patterns to subsequent visitors to a web page. Basically, the destination data allows users to see suggestions as to what the overall user population is doing at a web page, including an indication of where the users were before they came to a web page, and where they go after they leave the web page. It should be noted that when a search engine receives raw navigation data and analyzes the data, the refined navigation data stored in the repository, in one embodiment, is dynamically updated as new data is received.

By refining the accumulated navigation data provided by George and others, the search engine is able to determine that user's who access computer retailer A's web page also frequently access an online computer review web page, a computer game web page, and a recipe exchange web page. Accordingly, an association between computer retailer A's web page and the other web pages is stored in the refined navigation data repository. When users access computer retailer A's web page, the association between computer retailer A's web page and the computer review web page, the computer game web page, and the recipe exchange web page may be retrieved and sent to the users as part of the destination data for computer retailer A's web page upon request by the users' web browsers.

As George browses various computer retailers's web pages looking for a computer to buy, each time he navigates to a new web page, a request message is created and sent to the search engine. The request message includes the web page's URL and an indication that George would like to be shown destination data associated with that web page. For example, when George accesses computer retailer A's web page (e.g., by entering computer retailer A's URL in the address box of his web browser), the tracking mechanism intercepts the HTTP request message. The tracking mechanism extracts the requested URL, creates a destination data request message, and sends the destination data request message to the search engine. Meanwhile, the original HTTP request message is forwarded to computer retailer A's web server.

In one embodiment, the tracking mechanism also listens to the web browser to determine if George cancels the request to access the web page or if there are other problems loading the requested web page. If the requested page does not load, the tracking mechanism, in one embodiment, issues its own cancel message to the search engine. Alternatively, if the requested web page cannot be found, the tracking message intercepts the destination data before it reaches the web browser. In one embodiment, if an error loading a requested web page occurs, the destination is still displayed to the user so the user can elect to browse to a different web page.

Assume there are no issues when George requests access to computer retailer A's web page. When the search engine receives the request message from the tracking mechanism, the search engine searches its databases for destination data associated with computer retailer A's web page. The destination data may include navigation data, search engine data, publisher-fed data, and advertiser-fed data as discussed in connection with FIG. 1. If the search engine finds information associated with the indicated web address, then the search engine sends the associated destination data back to George.

In one embodiment, the search engine does not find results associated directly with the requested URL. In such a case, the search engine may look for results associated with different web pages from the same site. For example, if the requested URL is for a web page other than the main web page for a website, then the search engine can search and return destination data associated with the main web page, if deemed relevant.

The actual presentation of the destination data can vary. For example, in one embodiment, the navigation data and search engine data are displayed in separate user interface controls. Alternatively, all the data may be organized in the same user interface control. In one embodiment, the display interface for the destination data includes controls that allow the user to set preferences as to how the destination data is displayed.

In one embodiment, the toolbar installed by George includes controls that allow George to selectively filter the destination data that is displayed to him. For example, the options include controls to filter refined navigation data or advertiser data from the destination data. This filtering may be done by the tracking mechanism, or it may be done by the toolbar itself.

In addition, the toolbar includes controls that allow George to filter the amount of destination data displayed and how the destination data is presented to the user. For example, George decides he would only like to see the top three results from the refined navigation data and nothing else. In one embodiment, the toolbar includes controls that allow him to filter all but the refined navigation data. Moreover, the toolbar includes controls that allow George to specify the number of results that are displayed. Hence, the excess information is filtered out and George is able to customize his view of the destination data.

For example, George accesses computer retailer A's main web page with the filter set to exclude all the destination data except for the top three results from the refined navigation. As a result, the destination data he is shown in the display interface includes links to the computer review web page, the computer game web page, and the recipe exchange web page as described above. Those web pages are listed since other users of computer retailer A's website also accessed those sites and, hence, were included in the refined navigation data repository.

Since George is not interested in those web pages. He is really only interested in buying a computer, he decides to alter the filter and remove all filters. As a result, the tracking mechanism removes the filters on the received destination data and displays all the results returned by the search engine. For example, the destination data now includes a publisher-submitted link to a “Purchase Computer” web page (“buy web page”). Basically, computer retailer A wants visitors to their website to not only browse their website but buy a computer while they are there. Therefore, computer-retailer A submitted the buy web page to the search engine and associated the buy web page with other web pages on their website.

In one embodiment, the publisher-fed data displayed in the display interface may also include links to commonly-owned domains or partner sites.

The publisher-fed data may include promotions, coupons, or other information. For example, as George is browsing computer retailer A's web page, the toolbar receives and displays destination data that describes a special promotion the computer retailer is having on computers. In this case, the promotional offer states that if George buys a computer today from computer retailer A, then the computer retailer will include a free printer and year-long subscription to an antivirus program. In one embodiment, the promotional offer includes a link to a web page that describe the deal in more detail and also allows the user to purchase the computer. George follows the link to review the offer.

Note that as George transitions from the computer retailer A's main page to the promotional web page, the transition is recorded and sent to the search engine by the tracking mechanism to help identify trends in user browsing patterns. At the same time, when George transitions from computer retailer A's main web page to the promotional web page address, the URL for the promotional web page is submitted by the tracking mechanism to the search engine in order to find destination data associated with the promotional web page. When the promotional web page is loaded, the destination data is also updated to include additional sites and information associated with the promotional web page. Some of the new destination data may include a link to the printer manufacturer's web page and another link to the anti-virus manufacturer's web page.

For example, users who access the promotional offer also browse to the printer manufacturer's web page to find out details about the printer. Accordingly, this trend was identified by analyzing the clickstreams of users that accessed the promotional web page and an association was created between the printer's web page and the promotional web page. The association was stored as refined navigation data, and is displayed in connection with other destination data. George decides to follow the printer link to find out more about the printer.

When George transitions to the printer web page, the destination data is again updated. In one embodiment, the destination data includes a link back to the promotional web page (since many users who access the printer web page came from the promotional web page). Moreover, the destination data for the printer web page includes advertiser submitted data. For example, as George browses the printer web page, he is shown links to printer ink cartridges refills, graphic development software, paper products, and other printer products.

In one embodiment, the destination data includes search engine data such as related links, stock quote information for the printer manufacturer, an abstract of the printer's main web page, and a thumbnail picture of the printer manufacturer's main web page.

Additional search engine data may also generated by the search engine. For example, an analysis of the printer web page's content by the search engine may generate search terms that are related to the web page's content. Those search terms, in one embodiment, are submitted as keywords to the search engine. The search results for those search terms are included in the destination data.

According to one embodiment, a web page publisher may request that no destination data be displayed for a page. Accordingly, a token mechanism may be sent with a web page address to indicate to the tracking mechanism that a destination data request message should not be sent. Alternatively, the search engine may maintain a whitelist of web page addresses whose publishers have requested that no destination data be sent.

For example, suppose computer retailer A did not want any other information to distract George from buying a computer. Accordingly, computer retailer A associates a token with the promotional web page that tells the tracking mechanism not to send a request for destination data. Accordingly, no destination data is displayed when George accesses the promotional web page.

After reviewing the promotional web page and other related information, George decides he likes compute retailer A's offer and proceeds to purchase the computer.

Note that subsequent visitors to computer retailer A's web page, even if they do not have a web browser with an integrated toolbar like George, still can receive some of the benefits of destination data. In one embodiment, users have access to destination data through a standard search engine interface. For example, when a subsequent user, Richard, performs a search query in a search engine, the search results can include more than just standard search engine data results. The search results can be enhanced to include all the various forms of destination data as described herein. In this way, searching and navigating techniques are improved.

### Hardware Overview

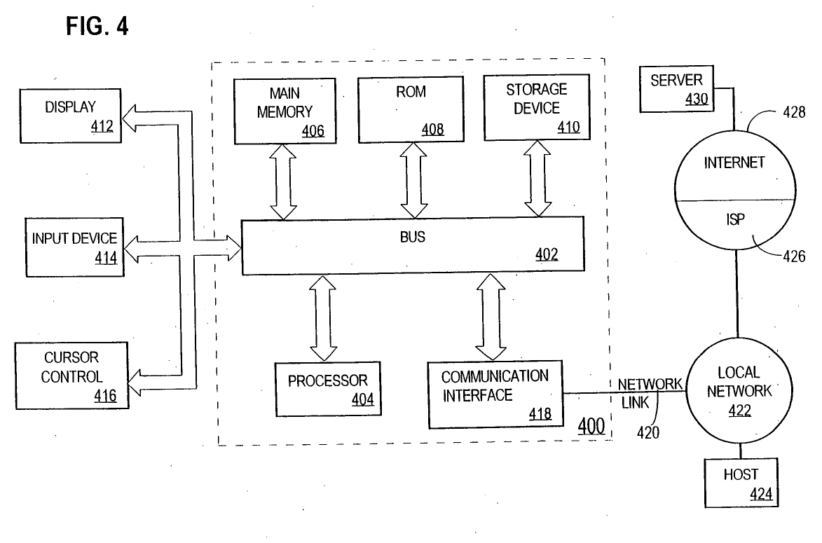

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one implementation of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative implementations, hard-wired circuitry may be used in place of or in combination with software instructions to implement the invention. Thus, implementations of the invention are not limited to any specific combination of hardware circuitry and software.

The term “machine-readable medium” as used herein refers to any medium that participates in providing data that causes a machine to operation in a specific fashion. In an implementation implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, implementations of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for providing targeted data to a set of users comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
maintaining page transition information that indicates page-to-page transitions made by the set of users;
updating the page transition information to record that a first user navigated from a first page to a second page;
in response to a request by a second user to navigate to the first page, inspecting the page transition information to determine one or more other pages to which prior visitors of the first page navigated; and
presenting to the second user controls for navigating to said one or more other pages.

2. The method of claim 1, wherein the page-to-page transitions include captured page-to-page transition information.

3. The method of claim 1 wherein said first page comprises a web page

4. The method of claim 1, wherein the page transition information further comprises data extracted from a search engine.

5. The method of claim 3, wherein the data extracted from the search engine includes information submitted by a publisher of the first page.

6. The method of claim 3, wherein the data extracted from the search engine includes information submitted by an advertiser of the first page.

7. The method of claim 3, wherein the search engine data includes any of an abstract, metadata, a related link, and a summary.

8. The method of claim 1, wherein the page-to-page transitions are specific to a user in the set of users.

9. The method of claim 1, wherein presenting to the second user controls for navigating to said one or more other pages includes displaying the one or more other pages in a web browser toolbar.

10. The method of claim 1, wherein presenting to the second user controls for navigating to said one or more other pages includes displaying the one or more other pages in a overlay window in a web browser.

11. The method of claim 1, wherein updating the page transition information to record that a first user navigated from a first page to a second page is performed anonymously.

12. The method of claim 1, wherein updating the page transition information to record that a first user navigated from a first page to a second page includes receiving an indication of consent from the first user before page transition information is recorded.

13. The method of claim 12, receiving the indication of consent may be selectively revoked by the first user.

14. The method of claim 1, wherein inspecting the page transition information to determine one or more other pages to which prior visitors of the first page navigated includes evaluating the page-to-page transitions to find a common pattern of page access among the set of users.

15. The method of claim 14, wherein the page-to-page transitions include page-to-page transitions that are separated by one or more intervening transitions.
